(19) United States
(12) Patent Application Publication
(10) Pub. No.: US 2018/0162668 A1
(43) Pub. Date: Jun. 14, 2018

(54) AUTO SPLICING DEVICE OF ROLL TO ROLL FEEDING EQUIPMENT

(71) Applicants: Hyundai Motor Company, Seoul (KR); Kia Motors Corporation, Seoul (KR)

(72) Inventor: Yoosuk Hong, Paju (KR)

(21) Appl. No.: 15/651,615

(22) Filed: Jul. 17, 2017

(30) Foreign Application Priority Data
Dec. 14, 2016 (KR) 10-2016-0170786

(51) Int. Cl. B65H 19/18; B65H 19/20; B65H 19/10; B65H 20/02; B65H 23/00; H01M 8/1004

(52) U.S. Cl. CPC B65H 19/1873; B65H 19/1889; B65H 19/20; B65H 19/102; B65H 20/02; B65H 2701/19; H01M 8/1004; B65H 2301/46312; B65H 2301/46222; B65H 2301/46072; B65H 2301/46022; B65H 23/005

(57) ABSTRACT

An auto splicing apparatus of roll to roll feeding equipment includes first and second supply rolls in which component fabric of a single layer is wound in roll form and the component fabric is unwound from the first supply roll or the second supply roll along a predetermined transfer path including a pair of feeding rollers that are disposed at upper and lower sides, respectively, of the transfer path; a first cutter assembly that is installed to perform a first vertical rotation based on the transfer path between the first supply roll and the feeding roller and including a first fabric cutter and a first fabric absorption portion; and a second cutter assembly that is installed to perform a second vertical rotation based on the transfer path between the second supply roll and the feeding roller and including a second fabric cutter and a second fabric absorption portion.

### CROSS-REFERENCE TO RELATED APPLICATION

This application claims under 35 U.S.C. § 119(a) the benefit of Korean Patent Application No. 10-2016-0170786 filed in the Korean Intellectual Property Office on Dec. 14, 2016, the entire contents of which are incorporated herein by reference.

### BACKGROUND

### (a) Technical Field

The present disclosure relates to roll to roll feeding equipment, more particularly, to an auto splicing apparatus that replaces a supply roll in which component fabric is exhausted with a new supply roll and that automatically connects component fabric of the exhausted supply roll and component fabric of the new supply roll in roll to roll feeding equipment that produces a fuel cell component while supplying component fabric with a roll to roll method.

### (b) Description of the Related Art

As is well known, in production of a fuel cell and a rechargeable battery, battery components are produced by a method of continuously supplying battery component fabric with a roll to roll method and bonding battery elements such as an electrode to the component fabric.

In an example of producing a Membrane-Electrode Assembly (MEA), which is a core component of a fuel cell, with a roll to roll method, an electrolyte film that is wound in a roll form is unwound, and electrode catalyst layers are continuously transferred to be separated at a predetermined gap at both surfaces of the electrolyte film, and thus electrode film fabric is produced.

Thereafter, in a post-process, the electrode film fabric that is wound in a roll form is unwound and transferred, sub gasket fabric of a roll form is wound and located at both surfaces of the electrode film fabric, passes through between hot rollers, and MEA fabric that bonds the sub gasket fabric to both surfaces of the electrode film fabric is produced.

In a process of feeding component fabric with a roll to roll method, when the entire fabric that is wound in a fabric supply roll is unwound and exhausted, a supply roll (hereinafter, referred to as an “exhaustion roll” or a “work roll”) in which the component fabric is exhausted should be replaced with a new supply roll (hereinafter, referred to as a “new roll” or a “preliminary roll”). For this reason, in order to continuously supply component fabric, a work is required that connects an end portion of component fabric that is unwound from the exhaustion roll to the front end of component fabric that is unwound from the new roll, and such a process is referred to as a splicing process.

In a conventional splicing process, in a state in which an exhaustion roll is taken out and in which a new roll is mounted at a location of the exhaustion roll, a work that bonds component fabric of the exhaustion roll to component fabric of the new roll is performed manually.

Therefore, in the conventional art, it is difficult for even a skilled operator to replace an exhaustion roll with a new roll and connect component fabric of these rolls within a short time, and a level of difficulty of a connection work gradually increases according to a trend that produces battery components in a small thickness.

Further, in the conventional art, as a production process of a battery component is performed at high speed, replacement of many rolls is performed at a production spot, work time for replacing an exhaustion roll with a new roll and for connecting component fabric of these rolls is increased, and frequent stopping of a production process is required, and thus productivity may be deteriorated.

Further, in the conventional art, when continuously supplying component fabric of two layers including a protection film to component fabric, it is further difficult to connect component fabric of these rolls according to replacement of an exhaustion roll and a new roll, and thus a work time and a non-operation time of an equipment are increased.

The above information disclosed in this Background section is only for enhancement of understanding of the background of the disclosure and therefore it may contain information that does not form the prior art that is already known in this country to a person of ordinary skill in the art.

### SUMMARY

The present disclosure provides an auto splicing apparatus of a roll to roll feeding equipment having advantages of being capable of automatically connecting an end portion of component fabric that is unwound from an exhaustion roll to the front end of component fabric that is unwound from a new roll.

An exemplary embodiment of the present disclosure provides an auto splicing apparatus of a roll to roll feeding equipment including a first supply roll and second supply roll in which component fabric of a single layer is wound in a roll form and that supplies component fabric that is unwound from the first supply roll or the second supply roll along a predetermined transfer path including: i) a pair of feeding rollers that are disposed at the upper and lower sides, respectively of the transfer path and that transfer component fabric while rotating with engaged each other and having any one that enables to perform a vertical movement and driving rotation; ii) a first cutter assembly that is installed to perform a vertical rotation based on the transfer path between the first supply roll and the feeding roller and including a fabric cutter and a fabric absorption portion; and iii) a second cutter assembly that is installed to perform a vertical rotation based on the transfer path between the second supply roll and the feeding roller and including a fabric cutter and a fabric absorption portion.

The auto splicing apparatus may further include detecting sensors that are installed at the first supply roll and second supply roll sides, respectively and that detect whether component fabric of each roll is exhausted and that output a detection signal thereof to a controller.

The detecting sensor may detect a diameter of component fabric that is wound in the first and second supply rolls.

The detecting sensor may detect a label of the end portion side of component fabric that is wound in the first and second supply rolls.

The second cutter assembly may absorb the front end of component fabric that is wound in the second supply roll with vacuum suction pressure through the fabric absorption portion and absorb the front end of component fabric to which a double-sided adhesive tape is attached, when the first supply roll is a work roll and when the second supply roll is a preliminary roll, and the first cutter assembly may absorb the front end of component fabric that is wound in the first supply roll with vacuum suction pressure through the fabric absorption portion and absorb the front end of component fabric to which a double-sided adhesive tape is attached, when the first supply roll is a preliminary roll and when the second supply roll is a work roll.

The first and second cutter assemblies when the first supply roll is a work roll and when the second supply roll is a preliminary roll may rotate toward the transfer path and attach the front end of component fabric of the second supply roll and an end portion of component fabric of the first supply roll through the double-sided adhesive tape at a time point at which component fabric of the first supply roll is exhausted.

The first cutter assembly may absorb the end portion of component fabric of the first supply roll with vacuum pressure through the fabric absorption portion and cut the end portion of component fabric of the first supply roll through the fabric cutter.

The first and second cutter assemblies when the first supply roll is a preliminary roll and when the second supply roll is a work roll may rotate toward the transfer path and attach the front end of component fabric of the first supply roll and an end portion of component fabric of the second supply roll through the double-sided adhesive tape at a time point at which component fabric of the second supply roll is exhausted.

The second cutter assembly may absorb the end portion of component fabric of the second supply roll with vacuum pressure through the fabric absorption portion and cut the end portion of component fabric of the second supply roll through the fabric cutter.

A scale may be provided in the fabric absorption portion of the first and second cutter assemblies.

Another embodiment of the present disclosure provides an auto splicing apparatus of a roll to roll feeding equipment including first and second supply rolls in which component fabric of two layers in which film fabric is attached to base fabric is wound in a roll form and that supplies component fabric that is unwound from the first supply roll or the second supply roll along a predetermined transfer path including: i) a pair of feeding rollers that are disposed at the upper and lower sides, respectively of the transfer path and that transfer component fabric while rotating with engaged each other and having any one that enables to perform a vertical movement and driving rotation; ii) a first cutter assembly that is installed to perform a vertical rotation based on the transfer path between the first supply roll and the feeding roller and including a fabric cutter and a fabric absorption portion; iii) a second cutter assembly that is installed to perform a vertical rotation based on the transfer path between the second supply roll and the feeding roller and including a fabric cutter and a fabric absorption portion; and iv) first and second absorption moving rollers that are rotatably provided at the first and second supply rolls sides, respectively and that are installed to perform a reciprocating movement along the transfer path and that absorb base fabric and film fabric of each component fabric that is wound in the first and second supply rolls, respectively.

The second cutter assembly may absorb the front end of base fabric of component fabric that is wound in the second supply roll with vacuum suction pressure through the fabric absorption portion and absorb the front end of base fabric to which a double-sided adhesive tape is attached, when the first supply roll is a work roll and when the second supply roll is a preliminary roll.

The second absorption moving roller may absorb the front end of film fabric of component fabric that is wound in the second supply roll with vacuum suction pressure and absorb the front end of film fabric to which a double-sided adhesive tape is attached.

The first and second cutter assemblies may rotate toward the transfer path and attach the front end of base fabric of the second supply roll and an end portion of base fabric of the first supply roll through the first double-sided adhesive tape at a time point at which component fabric of the first supply roll is exhausted.

The first cutter assembly may absorb an end portion of component fabric of the first supply roll with vacuum pressure through the fabric absorption portion and cut the end portion of component fabric of the first supply roll through the fabric cutter.

The second absorption moving roller may move to the transfer path side and attach the end portion of film fabric of component fabric of the first supply roll that is cut through the first cutter assembly and the front end of film fabric of component fabric of the second supply roll through the second double-sided adhesive tape, and move to an original location in a state in which the first and second cutter assemblies are rotated to an original location.

The first cutter assembly may absorb the front end of film fabric of component fabric that is wound in the first supply roll with vacuum suction pressure through the fabric absorption portion and absorb the front end of film fabric to which a first double-sided adhesive tape is attached, when the first supply roll is a preliminary roll and when the second supply roll is a work roll.

The first absorption moving roller may absorb the front end of base fabric of component fabric that is wound in the first supply roll with vacuum suction pressure and absorb the front end of base fabric to which a second double-sided adhesive tape is attached.

The first and second cutter assemblies may rotate toward the transfer path and attach the front end of film fabric of the first supply roll and an end portion of film fabric of the second supply roll through the first double-sided adhesive tape at a time point at which component fabric of the second supply roll is exhausted.

The second cutter assembly may absorb the end portion of component fabric of the second supply roll with vacuum pressure through the fabric absorption portion and cut the end portion of component fabric of the second supply roll through the fabric cutter.

The first absorption moving roller may move to the transfer path side, attach the end portion of base fabric of component fabric of the second supply roll that is cut through the second cutter assembly and the front end of base fabric of component fabric of the first supply roll through the second double-sided adhesive tape, and move to an original location in a state in which the first and second cutter assemblies are rotated to an original location.

### BRIEF DESCRIPTION OF THE DRAWINGS

FIGS. 1A and 1B are schematic diagrams illustrating an auto splicing apparatus of roll to roll feeding equipment according to an exemplary embodiment of the present disclosure.

FIG. 2 is a schematic diagram illustrating a detecting sensor that is applied to an auto splicing apparatus of roll to roll feeding equipment according to an exemplary embodiment of the present disclosure.

FIG. 3 is a schematic diagram illustrating a fabric absorption portion of first and second cutter assemblies that are applied to an auto splicing apparatus of roll to roll feeding equipment according to an exemplary embodiment of the present disclosure.

FIGS. 4A to 4C and 5A to 5C are schematic diagrams illustrating operation of an auto splicing apparatus of roll to roll feeding equipment according to an exemplary embodiment of the present disclosure.

FIGS. 6A and 6B are schematic diagrams illustrating an auto splicing apparatus of roll to roll feeding equipment according to another exemplary embodiment of the present disclosure.

FIGS. 7A to 7D and 8A to 8D are schematic diagrams illustrating operation of an auto splicing apparatus of roll to roll feeding equipment according to an exemplary embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present disclosure will be described more fully hereinafter with reference to the accompanying drawings, in which exemplary embodiments of the disclosure are shown.

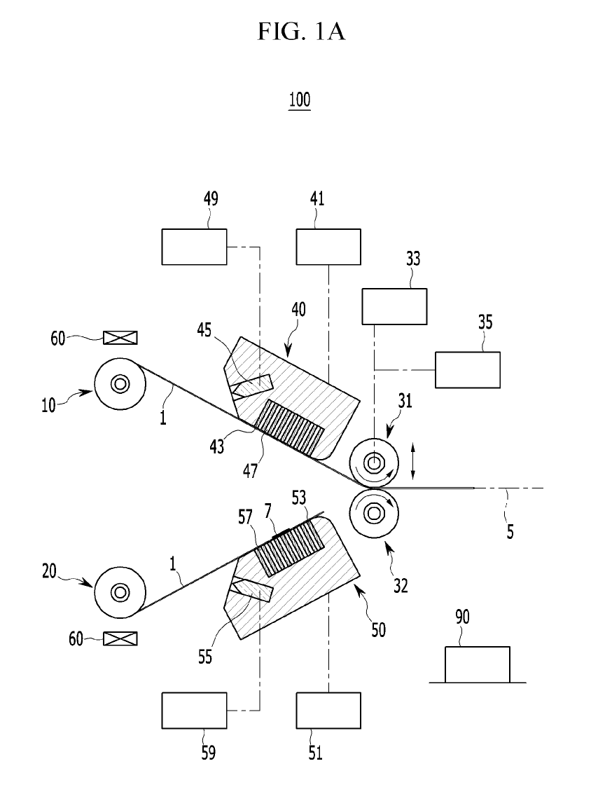

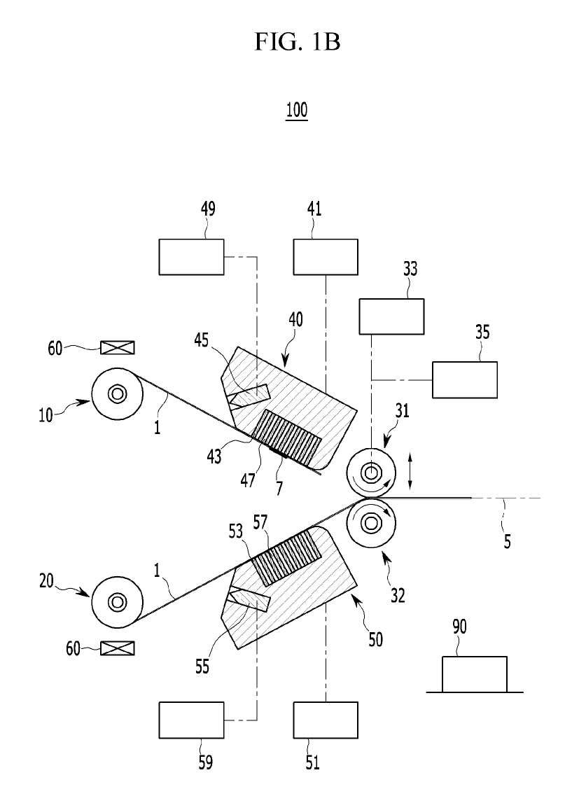

FIGS. 1A and 1B are schematic diagrams illustrating an auto splicing apparatus of roll to roll feeding equipment according to an exemplary embodiment of the present disclosure.

Referring to FIGS. 1A and 1B, an auto splicing apparatus 100 of roll to roll feeding equipment according to an exemplary embodiment of the present disclosure may be applied to a battery component production system that automatically continuously produces a battery component of a fuel cell or a rechargeable battery.

For example, a battery component that is applied to an exemplary embodiment of the present disclosure is a core component of a fuel cell and may include a Membrane-Electrode Assembly (MEA) to which an electrode layer and a sub gasket are bonded to both surfaces of an electrolyte film.

The battery component production system may automatically continuously produce a fuel cell component and unwind an electrolyte film that is wound in roll form, so as to continuously transfer an electrode catalyst layer to separate by a predetermined gap both surfaces of the electrolyte film, thereby producing electrode film fabric.

The battery component production system may unwind and transfer electrode film fabric that is wound in roll form, unwind sub gasket fabric of roll form to locate the sub gasket fabric at both surfaces of the electrode film fabric, pass through the sub gasket fabric between hot rollers, and bond sub gasket fabric to both surfaces of the electrode film fabric, thereby producing MEA fabric.

As provided herein, a roll to roll method is a method of unwinding component fabric that is wound in roll form, transferring the component fabric through a plurality of transfer rollers along a predetermined path, and forming a predetermined component element at both surfaces of the component fabric.

Hereinafter, roll to roll feeding equipment that continuously supplies component fabric that is wound in roll form with a roll to roll method is exemplified. The roll to roll feeding equipment may be defined as equipment in which a plurality of transfer rollers are rotatably installed at an installation surface of a frame that is arranged in a vertical direction.

Each constituent element to be described hereinafter may be configured in a vertical direction and a front-rear direction (lateral direction) in a frame of the roll to roll feeding equipment. The frame supports each constituent element and may be configured with one frame or at least two partitioned frames.

The frame may include various accessory elements such as a bracket, a bar, a rod, a plate, a housing, a case, and a block for supporting each constituent element. However, the various accessory elements enable each constituent element to be described hereinafter to install in a frame, and in an exemplary embodiment of the present disclosure, the accessory elements are generally referred to as a frame.

Such roll to roll feeding equipment includes a first supply roll 10 and second supply roll 20 in which component fabric 1 of a single layer is wound in roll form. The first and second supply rolls 10 and 20 are separately disposed in a vertical direction at the front side of the above-described frame.

Any one of the first and second supply rolls 10 and 20 unwinds the component fabric 1 to a predetermined transfer path 5, and hereinafter, a supply roll that unwinds the component fabric 1 is referred to as a work roll. Hereinafter, the other supply roll that does not unwind the component fabric 1 is referred to as a preliminary roll.

That is, when any one of the first and second supply rolls 10 and 20 is a work roll, the other supply roll is a preliminary roll for unwinding the component fabric 1 after the component fabric 1 of the work roll is exhausted.

Here, at any one work roll of the first and second supply rolls 10 and 20, when the component fabric 1 is exhausted, the any one work roll is replaced with a preliminary roll and from this time, the other one preliminary roll becomes a work roll.

In the roll to roll feeding equipment, the auto splicing apparatus 100 according to an exemplary embodiment of the present disclosure is formed in a structure that automatically connects an end portion of the component fabric 1 that is unwound from a work roll among the first and second supply rolls 10 and 20 to the front end of the component fabric 1 that is unwound from a preliminary roll and that continuously supplies the component fabric 1.

For this reason, the auto splicing apparatus 100 of the roll to roll feeding equipment according to an exemplary embodiment of the present disclosure includes a pair of feeding rollers 31 and 32, a first cutter assembly 40, a second cutter assembly 50, and a detecting sensor 60.

In an exemplary embodiment of the present disclosure, in the first and second supply rolls 10 and 20 that are separately disposed in a vertical direction at the front side of the frame of the roll to roll feeding equipment, the pair of feeding rollers 31 and 32 are disposed at the upper and lower sides, respectively, of the transfer path 5 between the first and second supply rolls 10 and 20.

The pair of feeding rollers 31 and 32 are rotatably installed in an opposite direction in the frame. Hereinafter, the feeding roller 31 that is installed at the upper side is referred to as an “upper feeding roller”, and the feeding roller 32 that is installed at the lower side is referred to as a “lower feeding roller”. The upper feeding roller 31 and the lower feeding roller 32 rotate while being engaged with each other and transfer the component fabric 1 that is unwound from the first supply roll 10 or the second supply roll 20 along the transfer path 5.

The upper feeding roller 31 is installed to perform a reciprocating motion in a vertical direction along a guide rail (not shown) that is provided in a vertical direction in the frame. The upper feeding roller 31 may move in a vertical direction along a guide rail by a first driving source 33 including an operation cylinder (pneumatic pressure cylinder or hydraulic pressure cylinder).

In this way, the reason of installing the upper feeding roller 31 to perform a reciprocating motion in a vertical direction along a guide rail by the first driving source 33 is to move the upper feeding roller 31 in an upward direction and to set the component fabric 1 of the work roll to the transfer path 5, when mounting a work roll of any one of the first and second supply rolls 10 and 20 in the frame.

The upper feeding roller 31 may be driven to rotate by a second driving source 35 including a servo motor while moving in a vertical direction by the first driving source 33. The upper feeding roller 31 may be driven to rotate in one side direction (from the front side to the rear side) by the second driving source 35.

The lower feeding roller 32 engages with the upper feeding roller 31, and when the upper feeding roller 31 is driven to rotate by the second driving source 35, the lower feeding roller 32 is installed to rotate in a direction (from the rear side to the front side) opposite to a rotating direction of the upper feeding roller 31. That is, the lower feeding roller 32 is installed to perform an idle rotation in the frame.

In an exemplary embodiment of the present disclosure, when the first supply roll 10 is a work roll (see FIG. 1A), the first cutter assembly 40 absorbs and cuts an end portion of the component fabric 1 of the first supply roll 10.

The first cutter assembly 40 is installed to vertically rotate based on the transfer path 5 between the first supply roll 10 and the vertical feeding rollers 31 and 32. The first cutter assembly 40 is rotatably installed while drawing a revolving trajectory in a vertical direction along a guide rail (not shown) that is provided in a vertical revolving direction in the frame. The first cutter assembly 40 may rotate in a vertical direction along a guide rail by a third driving source 41 including an operation cylinder (pneumatic pressure cylinder or hydraulic pressure cylinder).

Such a first cutter assembly 40 includes a first fabric absorption portion 43 for absorbing an end portion of the component fabric 1 with vacuum suction pressure and a first fabric cutter 45 for cutting the end portion of the component fabric 1.

In the first fabric absorption portion 43, a plurality of vacuum suction holes 47 are formed in a predetermined absorption plate. Vacuum suction pressure may be applied to the vacuum suction holes 47 by driving of a vacuum pump (not shown) and may be blocked by a common valve.

Here, as described above, when the first supply roll 10 is a work roll, vacuum suction pressure is applied to the vacuum suction holes 47, and the first fabric absorption portion 43 may absorb the end portion of the component fabric 1 of the first supply roll 10 (see FIG. 1A). When the first supply roll 10 is a preliminary roll, vacuum suction pressure is applied to the vacuum suction holes 47, and the first fabric absorption portion 43 may absorb the front end of the component fabric 1 of the first supply roll 10 (see FIG. 1B).

When the first supply roll 10 is a work roll, the first fabric cutter 45 cuts the end portion of the component fabric 1 that is absorbed in the first fabric absorption portion 43 (see FIG. 1A). The first fabric cutter 45 is provided to move forward and backward in the body of the first cutter assembly 40. Such a first fabric cutter 45 is installed to move forward and backward by a fourth driving source 49 including an operation cylinder (pneumatic pressure cylinder or hydraulic pressure cylinder).

In an exemplary embodiment of the present disclosure, when the second supply roll 20 is a work roll (see FIG. 1B), the second cutter assembly 50 absorbs and cuts an end portion of the component fabric 1 of the second supply roll 20.

The second cutter assembly 50 is disposed at a lower portion of the first cutter assembly 40 between the second supply roll 20 and the vertical feeding rollers 31 and 32 and is installed to vertically rotate based on the transfer path 5.

The second cutter assembly 50 is rotatably installed while drawing a revolving trajectory in a vertical direction along a guide rail (not shown) that is provided in a vertical revolving direction in the frame. The second cutter assembly 50 may rotate in a vertical direction along a guide rail by a fifth driving source 51 including an operation cylinder (pneumatic pressure cylinder or hydraulic pressure cylinder).

Such a second cutter assembly 50 includes a second fabric absorption portion 53 for absorbing the end portion of the component fabric 1 with vacuum suction pressure and a second fabric cutter 55 for cutting the end portion of the component fabric 1.

In the second fabric absorption portion 53, a plurality of vacuum suction holes 57 are formed in a predetermined absorption plate. Vacuum suction pressure may be applied to the vacuum suction holes 57 by driving of a vacuum pump (not shown) and may be blocked by a common valve.

Here, as described above, when the second supply roll 20 is a work roll, vacuum suction pressure is applied to the vacuum suction holes 57, and the second fabric absorption portion 53 may absorb the end portion of the component fabric 1 of the second supply roll 20 (see FIG. 1B). When the second supply roll 20 is a preliminary roll, vacuum suction pressure is applied to the vacuum suction holes 57, and the second fabric absorption portion 53 may absorb the front end of the component fabric 1 of the second supply roll 20 (see FIG. 1A).

When the second supply roll 20 is a work roll, the second fabric cutter 55 cuts the end portion of the component fabric 1 that is absorbed in the second fabric absorption portion 53 (see FIG. 1B). The second fabric cutter 55 is provided to move forward and backward at a body of the second cutter assembly 50. Such a second fabric cutter 55 is installed to move forward and backward by a sixth driving source 59 including an operation cylinder (pneumatic pressure cylinder or hydraulic pressure cylinder).

In an exemplary embodiment of the present disclosure, the detecting sensors 60 are installed in each of the first supply roll 10 and the second supply roll 20 sides. The detecting sensor 60 detects whether the component fabric 1 of each of the first and second supply rolls 10 and 20 is exhausted and outputs a detection signal thereof to a controller 90.

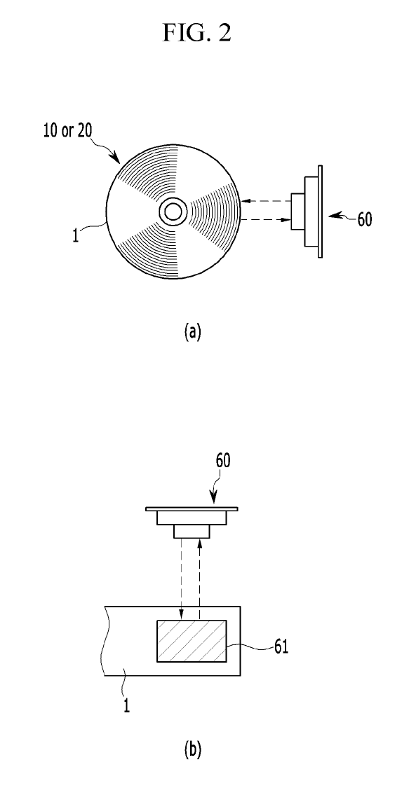

For example, as shown in FIG. 2A, the detecting sensor 60 may radiate ultrasonic waves or infrared rays to the component fabric 1 that is wound in the first and second supply rolls 10 and 20, detect a diameter of the component fabric 1 that is wound in the first and second supply rolls 10 and 20, and output a detection signal thereof to the controller 90.

Further, as shown in FIG. 2B, the detecting sensor 60 may radiate light such as infrared rays to the component fabric 1 that is wound in the first and second supply rolls 10 and 20, detect a label 61 that is attached to the end portion side of the component fabric 1, and output a detection signal thereof to the controller 90.

Such a detecting sensor 60 is a sensor of a common configuration that detects a diameter or a location of a body to be detected using ultrasonic waves or infrared rays and therefore, a detailed description thereof will be omitted.

In an auto splicing apparatus 100 of roll to roll feeding equipment according to an exemplary embodiment of the present disclosure having the above-described configuration, as shown in FIG. 1A, when the first supply roll 10 is a work roll and when the second supply roll 20 is a preliminary roll, the second cutter assembly 50 may absorb the front end of the component fabric 1 that is wound in the second supply roll 20 with vacuum suction pressure through the second fabric absorption portion 53. Here, the second cutter assembly 50 may absorb the front end of the component fabric 1 to which a double-sided adhesive tape 7 is attached.

In such a case, at a time point at which the component fabric 1 of the first supply roll 10 is exhausted, the first and second cutter assemblies 40 and 50 may rotate toward the transfer path 5 and attach the front end of the component fabric 1 of the second supply roll 20 and the end portion of the component fabric 1 of the first supply roll 10 through the double-sided adhesive tape 7.

The first cutter assembly 40 may absorb the end portion of the component fabric 1 of the first supply roll 10 with vacuum pressure through the first fabric absorption portion 43 and cut the end portion of the component fabric 1 of the first supply roll 10 through the first fabric cutter 45.

In an auto splicing apparatus 100 of roll to roll feeding equipment according to an exemplary embodiment of the present disclosure, as shown in FIG. 1B, when the first supply roll 10 is a preliminary roll and when the second supply roll 20 is a work roll, the first cutter assembly 40 may absorb the front end of the component fabric 1 that is wound in the first supply roll 10 with vacuum suction pressure through the first fabric absorption portion 43. Here, the first cutter assembly 40 may absorb the front end of the component fabric 1 to which the double-sided adhesive tape 7 is attached.

In such a case, at a time point at which the component fabric 1 of the second supply roll 20 is exhausted, the first and second cutter assemblies 40 and 50 may rotate toward the transfer path 5 and attach the front end of the component fabric 1 of the first supply roll 10 and the end portion of the component fabric 1 of the second supply roll 20 through the double-sided adhesive tape 7.

The second cutter assembly 50 may absorb the end portion of the component fabric 1 of the second supply roll 20 with vacuum pressure through the second fabric absorption portion 53 and cut the end portion of the component fabric 1 of the second supply roll 20 through the second fabric cutter 55.

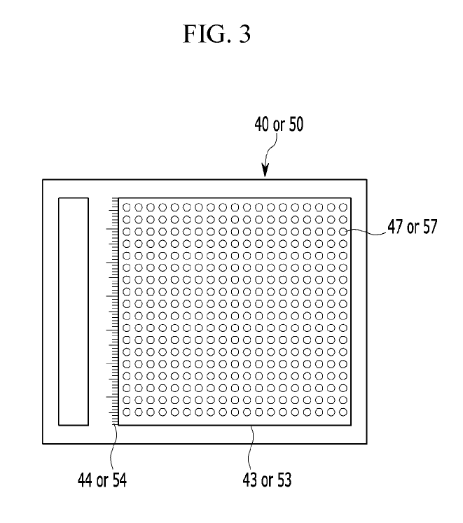

Further, in the first and second cutter assemblies 40 and 50, scales 44 and 54 of FIG. 3 are provided in the first and second fabric absorption portions 43 and 53, respectively. When the first supply roll 10 or the second supply roll 20 are a preliminary roll, the scales 44 and 54 determine a location of the front end of the component fabric 1 that is absorbed in the first fabric absorption portion 43 or the second fabric absorption portion 53.

That is, when the front end of the component fabric 1 of the preliminary roll and the end portion of the component fabric 1 of the work roll are attached through the double-sided adhesive tape 7 by rotation of the first and second cutter assemblies 40 and 50, the scales 44 and 54 are configured to accurately attach the front end of the component fabric 1 of the preliminary roll and the end portion of the component fabric 1 of the work roll.

In an exemplary embodiment of the present disclosure, when the front end of the component fabric 1 of the preliminary roll is set to absorb in the first fabric absorption portion 43 or the second fabric absorption portion 53, in order to correspond to a width of the component fabric 1 of the work roll, a front end location of the component fabric 1 of the preliminary roll may be checked and determined with the scales 44 and 54. Such scales 44 and 54 are formed at an edge of an absorption plate of the first and second fabric absorption portions 43 and 53, respectively, in a width direction of the component fabric 1.

Hereinafter, operation of an auto splicing apparatus 100 of roll to roll feeding equipment according to an exemplary embodiment of the present disclosure having the above-described configuration will be described in detail with reference to the attached drawings.

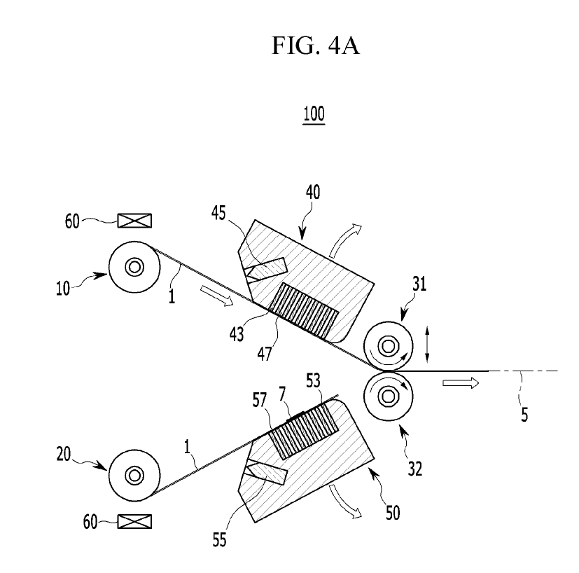

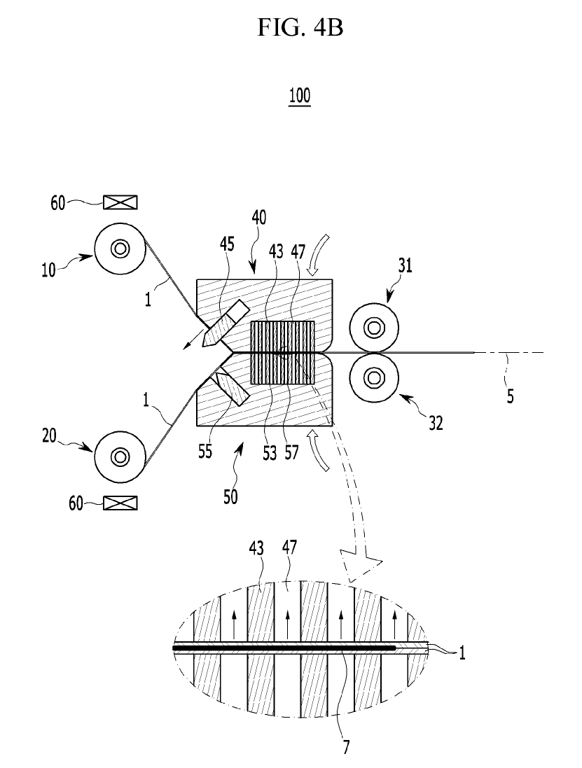

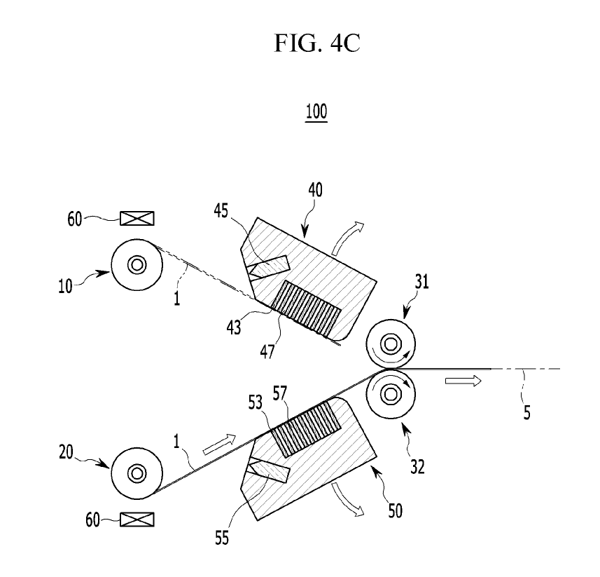

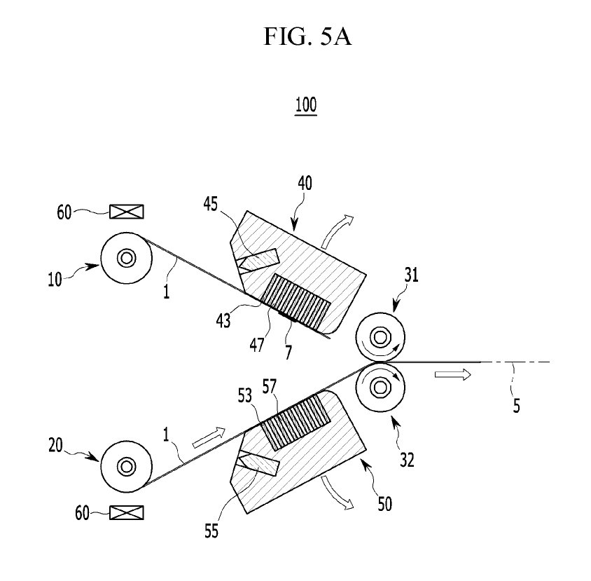

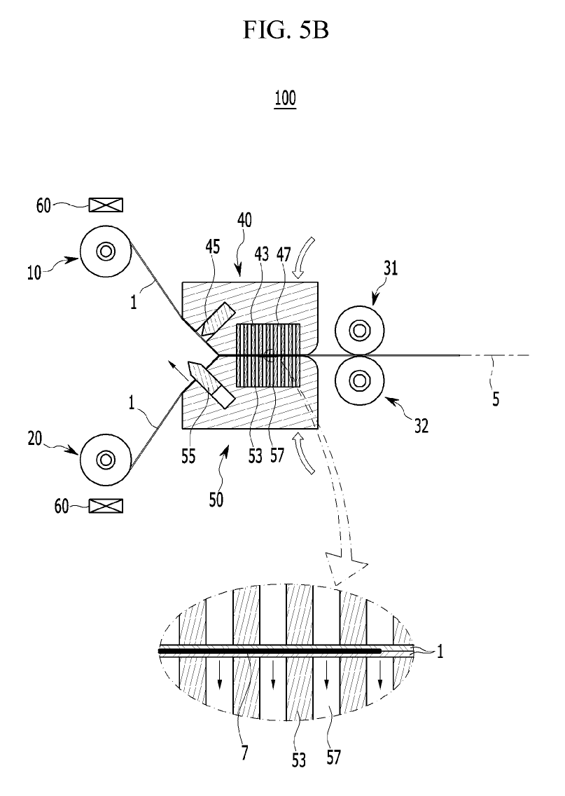

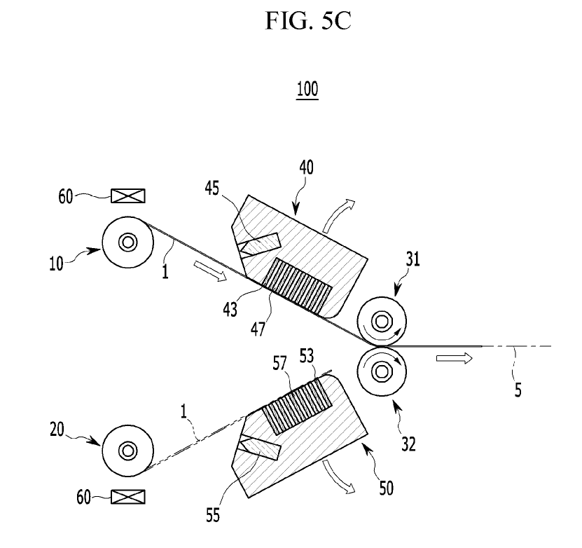

FIGS. 4A to 4C and 5A to 5C are schematic diagrams illustrating operation of an auto splicing apparatus of roll to roll feeding equipment according to an exemplary embodiment of the present disclosure.

Referring to FIG. 4A, in an exemplary embodiment of the present disclosure, when an initial first supply roll 10 is a work roll and when a second supply roll 20 is a preliminary roll, for example at the upper side of the front side of a frame of the roll to roll feeding equipment, the first supply roll 10 is mounted.

In this case, in an exemplary embodiment of the present disclosure, in a state in which an upper feeding roller 31 is moved in an upward direction along a guide rail by a first driving source 33, component fabric 1 of the first supply roll 10 is set to a transfer path 5. That is, the component fabric 1 of the first supply roll 10 is set between the upper feeding roller 31 and a lower feeding roller 32.

Thereafter, in an exemplary embodiment of the present disclosure, the upper feeding roller 31 is moved in a downward direction along a guide rail by a first driving source 33. Accordingly, the upper feeding roller 31 maintains a contact state with the lower feeding roller 32.

Thereafter, in an exemplary embodiment of the present disclosure, the second supply roll 20 is mounted at a lower portion of the first supply roll 10 at the front side of the frame. In this case, in an exemplary embodiment of the present disclosure, a first cutter assembly 40 rotates while drawing a revolving trajectory in an upward direction based on the transfer path 5 by a third driving source 41. The second cutter assembly 50 rotates while drawing a revolving trajectory in a downward direction based on the transfer path 5 by a fifth driving source 51. That is, the first and second cutter assemblies 40 and 50 rotate in a receding direction with the transfer path 5 interposed therebetween by the third driving source 41 and the fifth driving source 51, respectively. A first fabric cutter 45 and a second fabric cutter 55 of the first and second cutter assemblies 40 and 50 are in a backward state.

In such a state, in an exemplary embodiment of the present disclosure, vacuum suction pressure is applied to vacuum suction holes 57 of a second fabric absorption portion 53 of the second cutter assembly 50, and the front end of the component fabric 1 of the second supply roll 20 is absorbed in the second fabric absorption portion 53 with vacuum suction pressure through the vacuum suction holes 57.

Here, in an exemplary embodiment of the present disclosure, a scale 54 of the second fabric absorption portion 53 is determined, and the front end of the component fabric 1 is absorbed and set to a predetermined location of the second fabric absorption portion 53. Thereafter, in an exemplary embodiment of the present disclosure, a double-sided adhesive tape 7 is attached to an upper surface of the front end of the component fabric 1 that is absorbed in the second fabric absorption portion 53.

After the above process, in an exemplary embodiment of the present disclosure, the second driving source 35 is driven to rotate the upper feeding roller 31, rotate the lower feeding roller 32 contacting with the upper feeding roller 31, and feed the component fabric 1 of the first supply roll 10 entering between the rollers 31 and 32 in a post-process along the transfer path 5.

In such a process, in an exemplary embodiment of the present disclosure, the detecting sensor 60 detects whether the component fabric 1 of the first supply roll 10 is exhausted and outputs a detection signal thereof to a controller 90.

In an exemplary embodiment of the present disclosure, the detecting sensor 60 may radiate ultrasonic waves or infrared rays to the component fabric 1 that is wound in the first supply roll 10, detect a diameter of the component fabric 1 that is wound in the first supply roll 10, and output a detection signal thereof to the controller 90. In an exemplary embodiment of the present disclosure, the detecting sensor 60 may radiate light such as infrared rays to the component fabric 1 that is wound in the first supply roll 10, detect a label 61 that is attached to the end portion side of the component fabric 1, and output a detection signal thereof to the controller 90. Thereafter, the controller 90 receives a detection signal from the detecting sensor 60 to determine whether the component fabric 1 of the first supply roll 10 is exhausted.

In an exemplary embodiment of the present disclosure, if the component fabric 1 of the first supply roll 10 is exhausted, as shown in FIG. 4B, the controller 90 applies a control signal to the second driving source 35 to stop a driving rotation of the upper feeding roller 31.

Thereafter, in an exemplary embodiment of the present disclosure, the controller 90 applies a control signal to the third driving source 41 to rotate the first cutter assembly 40 to the transfer path 5 side while drawing a revolving trajectory in a downward direction. In an exemplary embodiment of the present disclosure, the controller 90 applies a control signal to a fifth driving source 51 to rotate the second cutter assembly 50 to the transfer path 5 side while drawing a revolving trajectory in an upward direction. That is, the first and second cutter assemblies 40 and 50 rotate in an approaching direction with the transfer path 5 interposed therebetween by the third driving source 41 and the fifth driving source 51, respectively.

Accordingly, in an exemplary embodiment of the present disclosure, the end portion of the component fabric 1 of the first supply roll 10 and the front end of the component fabric 1 of the second supply roll 20 are attached through the double-sided adhesive tape 7. In this case, the first cutter assembly 40 absorbs the end portion of the component fabric 1 of the first supply roll 10 by vacuum suction pressure that is applied to vacuum suction holes 47 of a first fabric absorption portion 43. Therefore, the end portion of the component fabric 1 of the first supply roll 10 and the front end of the component fabric 1 of the second supply roll 20 may be pressed by a pressure of the first and second cutter assemblies 40 and 50 with the double-sided adhesive tape 7 interposed therebetween and be attached through the double-sided adhesive tape 7.

Simultaneously, in an exemplary embodiment of the present disclosure, the controller 90 applies a control signal to a fourth driving source 49 to move forward the first fabric cutter 45 of the first cutter assembly 40 and cuts the end portion of the component fabric 1 of the first supply roll 10 through the first fabric cutter 45.

Thereafter, in an exemplary embodiment of the present disclosure, as shown in FIG. 4C, the controller 90 applies a control signal to the third driving source 41 to rotate the first cutter assembly 40 while drawing a revolving trajectory in an upward direction. In an exemplary embodiment of the present disclosure, the controller 90 applies a control signal to a fifth driving source 51 to rotate the second cutter assembly 50 while drawing a revolving trajectory in a downward direction. That is, the first and second cutter assemblies 40 and 50 rotate in a receding direction with the transfer path 5 interposed therebetween by the third driving source 41 and the fifth driving source 51 thereof, respectively.

After the above process, in an exemplary embodiment of the present disclosure, the second driving source 35 is driven to rotate the upper feeding roller 31, rotate the lower feeding roller 32 contacting with the upper feeding roller 31, and feed the component fabric 1 of the second supply roll 20 entering between the rollers 31 and 32 in a post-process along the transfer path 5. That is, in an exemplary embodiment of the present disclosure, in a state in which the end portion of the component fabric 1 of the first supply roll 10 is attached to the front end of the component fabric 1 of the second supply roll 20 through the double-sided adhesive tape 7, the component fabric 1 of the second supply roll 20 continuously feeds in a post-process. Accordingly, in an exemplary embodiment of the present disclosure, the second supply roll 20, which is an initial preliminary roll performs a function of a work roll and because the component fabric 1 is exhausted, the first supply roll 10, which is an initial work roll is replaced with a new preliminary roll.

Referring to FIG. 5A, as described above, when the first supply roll 10 is a newly replaced preliminary roll and when the second supply roll 20 is a work roll, in an exemplary embodiment of the present disclosure, the component fabric 1 that is unwound from the second supply roll 20 enters between the upper feeding roller 31 and the lower feeding roller 32 and feeds in a post-process along the transfer path 5.

In such a case, in an exemplary embodiment of the present disclosure, vacuum suction pressure is applied to the vacuum suction holes 47 of the first fabric absorption portion 43 of the first cutter assembly 40, and the front end of the component fabric 1 of the first supply roll 10 is absorbed in the first fabric absorption portion 43 with vacuum suction pressure through the vacuum suction holes 47.

Here, in an exemplary embodiment of the present disclosure, the scale 44 of the first fabric absorption portion 43 is determined, and the front end of the component fabric 1 is set to be absorbed at a predetermined location of the first fabric absorption portion 43. Thereafter, in an exemplary embodiment of the present disclosure, the double-sided adhesive tape 7 is attached to an upper surface of the front end of the component fabric 1 that is absorbed in the first fabric absorption portion 43.

As described above, in a process of feeding the component fabric 1 that is unwound from the second supply roll 20 in a post-process along the transfer path 5, in an exemplary embodiment of the present disclosure, the detecting sensor 60 detects whether the component fabric 1 of the second supply roll 20 is exhausted and outputs a detection signal thereof to the controller 90.

In an exemplary embodiment of the present disclosure, the detecting sensor 60 may radiate ultrasonic waves or infrared rays to the component fabric 1 that is wound in the second supply roll 20, detect a diameter of the component fabric 1 that is wound in the second supply roll 20, and output a detection signal thereof to the controller 90. In an exemplary embodiment of the present disclosure, the detecting sensor 60 may radiate light such as infrared rays to the component fabric 1 that is wound in the second supply roll 20, detect a label 61 that is attached to the end portion side of the component fabric 1, and output a detection signal thereof to the controller 90. Thereafter, the controller 90 receives a detection signal from the detecting sensor 60 to determine whether the component fabric 1 of the second supply roll 20 is exhausted.

In an exemplary embodiment of the present disclosure, if the component fabric 1 of the second supply roll 20 is exhausted, as shown in FIG. 5B, the controller 90 applies a control signal to the second driving source 35 to stop driving rotation of the upper feeding roller 31.

Thereafter, in an exemplary embodiment of the present disclosure, the controller 90 applies a control signal to a third driving source 41 to rotate the first cutter assembly 40 to the transfer path 5 side while drawing a revolving trajectory in a downward direction. In an exemplary embodiment of the present disclosure, the controller 90 applies a control signal to a fifth driving source 51 to rotate the second cutter assembly 50 to the transfer path 5 side while drawing a revolving trajectory in an upward direction. That is, the first and second cutter assemblies 40 and 50 rotate in an approaching direction with the transfer path 5 interposed therebetween by the third driving source 41 and the fifth driving source 51, respectively.

Accordingly, in an exemplary embodiment of the present disclosure, the end portion of the component fabric 1 of the second supply roll 20 and the front end of the component fabric 1 of the first supply roll 10 are attached through the double-sided adhesive tape 7. In this case, the second cutter assembly 50 absorbs the end portion of the component fabric 1 of the second supply roll 20 by vacuum suction pressure that is applied to the vacuum suction holes 57 of the second fabric absorption portion 53. Therefore, the end portion of the component fabric 1 of the second supply roll 20 and the front end of the component fabric 1 of the first supply roll 10 may be pressed by a pressure of the first and second cutter assemblies 40 and 50 with the double-sided adhesive tape 7 interposed therebetween and be attached through the double-sided adhesive tape 7.

Simultaneously, in an exemplary embodiment of the present disclosure, the controller 90 applies a control signal to a sixth driving source 59 to move forward the second fabric cutter 55 of the second cutter assembly 50 and cuts the end portion of the component fabric 1 of the second supply roll 20 through the second fabric cutter 55.

Thereafter, in an exemplary embodiment of the present disclosure, as shown in FIG. 5C, the controller 90 applies a control signal to the third driving source 41 to rotate the first cutter assembly 40 while drawing a revolving trajectory in an upward direction. In an exemplary embodiment of the present disclosure, the controller 90 applies a control signal to a fifth driving source 51 to rotate the second cutter assembly 50 while drawing a revolving trajectory in a downward direction. That is, the first and second cutter assemblies 40 and 50 rotate in a receding direction with the transfer path 5 interposed therebetween by the third driving source 41 and the fifth driving source 51, respectively.

After the above process, in an exemplary embodiment of the present disclosure, the second driving source 35 is driven to rotate the upper feeding roller 31, rotate the lower feeding roller 32 contacting with the upper feeding roller 31, and feed the component fabric 1 of the first supply roll 10 entering between the rollers 31 and 32 in a post-process along the transfer path 5. That is, in an exemplary embodiment of the present disclosure, in a state in which the end portion of the component fabric 1 of the second supply roll 20 is attached to the front end of the component fabric 1 of the first supply roll 10 through the double-sided adhesive tape 7, the component fabric 1 of the first supply roll 10 continuously feeds in a post-process. Accordingly, in an exemplary embodiment of the present disclosure, the first supply roll 10, which is a preliminary roll performs a function of a work roll, and because the component fabric 1 has been exhausted, the second supply roll 20, which is a work roll is replaced with a new preliminary roll.

By an auto splicing apparatus 100 of roll to roll feeding equipment according to an exemplary embodiment of the present disclosure of the foregoing description, in the roll to roll feeding equipment, the component fabric 1 of a single layer automatically connects the end portion of the component fabric 1 that is unwound from a work roll among the first and second supply rolls 10 and 20 that are wound in a roll form to the front end of the component fabric 1 that is unwound from a preliminary roll and thus the component fabric 1 is continuously supplied.

Therefore, in an exemplary embodiment of the present disclosure, because a work time and a non-operation time of a production process for connecting component fabric of a work roll and a preliminary roll may be shortened, productivity of a battery component can be further improved.

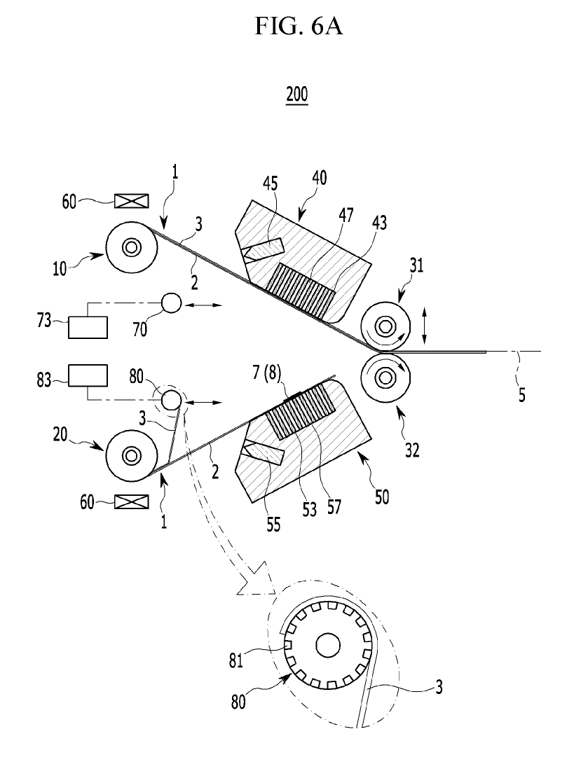

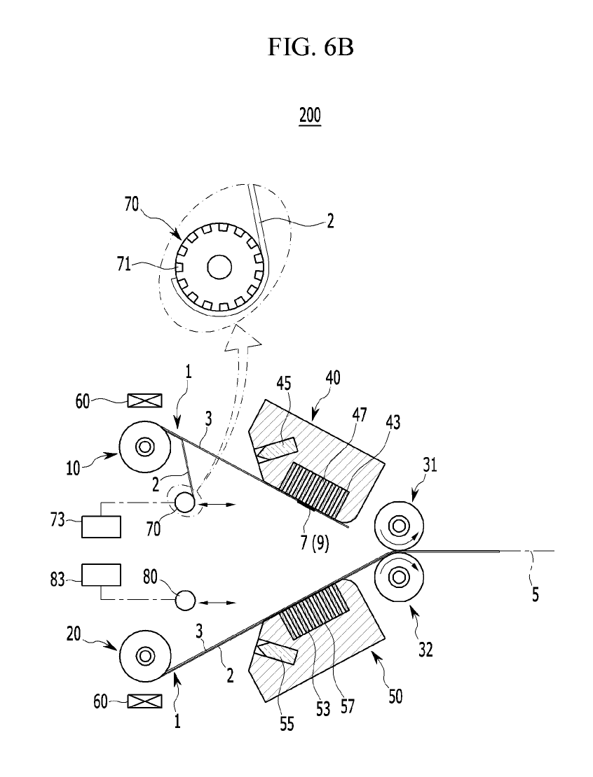

FIGS. 6A and 6B are schematic diagrams illustrating an auto splicing apparatus of roll to roll feeding equipment according to another exemplary embodiment of the present disclosure. In the drawing, in the present exemplary embodiment, the same reference numeral is given to a configuration corresponding to that of the foregoing exemplary embodiment.

Referring to FIGS. 6A and 6B, an auto splicing apparatus 200 of roll to roll feeding equipment according to another exemplary embodiment of the present disclosure has a structure that automatically connects an end portion of component fabric 1 that is unwound from a work roll among first and second supply rolls 10 and 20 in which the component fabric 1 of two layers is wound in a roll form to the front end of the component fabric 1 that is unwound from a preliminary roll and that enables the component fabric 1 to be continuously supplied.

Here, the component fabric 1 of two layers may be defined to component fabric in which film fabric 3 such as a protection film is attached to one side surface of base fabric 2 such as an electrolyte film of a fuel cell component.

An auto splicing apparatus 200 of roll to roll feeding equipment according to another exemplary embodiment of the present disclosure includes an upper feeding roller 31, a lower feeding roller 32, a first cutter assembly 40, a second cutter assembly 50, and a detecting sensor 60, as in the foregoing exemplary embodiment.

In the foregoing description, a configuration of the upper feeding roller 31 and the lower feeding roller 32, a first fabric absorption portion 43 and a first fabric cutter 45 of the first cutter assembly 40, a second fabric absorption portion 53 and a second fabric cutter 55 of the second cutter assembly 50, and the detecting sensor 60 is the same as that of the foregoing exemplary embodiment and therefore in this specification, a detailed description thereof will be omitted.

As shown in the drawing, in the component fabric 1 that is wound in a roll form in the first supply roll 10, the film fabric 3 is attached to an upper surface of the base fabric 2, and in the component fabric 1 that is wound in a roll form in the second supply roll 20, the film fabric 3 is attached to an upper surface of the base fabric 2.

In another exemplary embodiment of the present disclosure, the auto splicing apparatus 200 of the roll to roll feeding equipment includes first and second absorption moving rollers 70 and 80 that are rotatably provided at the first and second supply rolls 10 and 20 sides, respectively and that are installed to perform a reciprocating motion along a transfer path 5.

In an exemplary embodiment of the present disclosure, the first and second absorption moving rollers 70 and 80 substantially connect the base fabric 2 and the film fabric 3 of each component fabric 1 that is wound in the first and second supply rolls 10 and 20. The first and second absorption moving rollers 70 and 80 may absorb the base fabric 2 and the film fabric 3 of each component fabric 1 that is wound in the first and second supply rolls 10 and 20.

Specifically, as shown in FIG. 6A, the first absorption moving roller 70 is installed to perform an idle rotation in a frame of the roll to roll feeding equipment in a lower portion of the first supply roll 10. The first absorption moving roller 70 may absorb the front end of the base fabric 2 of the component fabric 1 that is unwound from the first supply roll 10 with vacuum suction pressure. Accordingly, as shown in FIG. 6B, at an external circumference surface of the first absorption moving roller 70, a plurality of vacuum suction holes 71 are formed. Vacuum suction pressure may be applied to the vacuum suction holes 71 by driving of a vacuum pump (not shown) and may be blocked by a common valve.

Further, the first absorption moving roller 70 is installed to perform a reciprocating motion in the front-rear direction (a lateral direction in the drawing) of the frame through a guide rail (not shown) that is provided along the transfer path 5. The first absorption moving roller 70 may perform a reciprocating motion in the front-rear direction of the frame along a guide rail by a seventh driving source 73 including an operation cylinder (pneumatic pressure cylinder or hydraulic pressure cylinder).

As shown in FIG. 6B, the second absorption moving roller 80 is installed to perform an idle rotation in the frame in a lower portion of the second supply roll 20. The second absorption moving roller 80 may absorb the front end of the film fabric 3 of the component fabric 1 that is unwound from the second supply roll 20 with vacuum suction pressure. Accordingly, as shown in FIG. 6A, at an external circumference surface of the second absorption moving roller 80, a plurality of vacuum suction holes 81 are formed. Vacuum suction pressure may be applied to the vacuum suction holes 81 by driving of a vacuum pump (not shown) and may be blocked by a common valve.

Further, the second absorption moving roller 80 is installed to perform a reciprocating motion in the front-rear direction (a lateral direction in the drawing) of the frame through a guide rail (not shown) that is provided along the transfer path 5. The second absorption moving roller 80 may perform a reciprocating motion in the front-rear direction of the frame along a guide rail by an eighth driving source 83 including an operation cylinder (pneumatic pressure cylinder or hydraulic pressure cylinder).

In an auto splicing apparatus 200 of roll to roll feeding equipment according to another exemplary embodiment of the present disclosure having the above-described configuration, as shown in FIG. 6A, when the first supply roll 10 is a work roll and when the second supply roll 20 is a preliminary roll, the second cutter assembly 50 absorbs the front end of the base fabric 2 of the component fabric 1 that is wound in the second supply roll 20 with vacuum suction pressure through the second fabric absorption portion 53. Here, the second cutter assembly 50 may absorb the front end of the base fabric 2 to which a first double-sided adhesive tape 8 is attached.

The second absorption moving roller 80 absorbs the front end of the film fabric 3 of the component fabric 1 that is wound in the second supply roll 20 with vacuum suction pressure through vacuum suction holes 81. Here, the second absorption moving roller 80 may absorb the front end of the film fabric 3 to which a second double-sided adhesive tape 9 is attached.

In such a case, at a time point at which the component fabric 1 of the first supply roll 10 is exhausted, the first and second cutter assemblies 40 and 50 may rotate toward the transfer path 5 and attach the front end of the base fabric 2 of the second supply roll 20 and the end portion of the base fabric 2 of the first supply roll 10 through the first double-sided adhesive tape 8.

Further, the first cutter assembly 40 may absorb the end portion of the component fabric 1 of the first supply roll 10 with vacuum suction pressure through the first fabric absorption portion 43 and cut the end portion of the component fabric 1 of the first supply roll 10 through the first fabric cutter 45.

In a state in which the first and second cutter assemblies 40 and 50 are rotated to an original location, the second absorption moving roller 80 moves to the transfer path 5 side. Accordingly, the second absorption moving roller 80 attaches an end portion of the film fabric 3 of the component fabric 1 of the first supply roll 10 that is cut through the first cutter assembly 40 and the front end of the film fabric 3 of the component fabric 1 of the second supply roll 20 through the second double-sided adhesive tape 9 and moves to an original location.

In an auto splicing apparatus 200 of roll to roll feeding equipment according to another exemplary embodiment of the present disclosure, as shown in FIG. 6B, when the first supply roll 10 is a preliminary roll and when the second supply roll 20 is a work roll, the first cutter assembly 40 absorbs the front end of the film fabric 3 of the component fabric 1 that is wound in the first supply roll 10 with vacuum suction pressure through the first fabric absorption portion 43. Here, the first cutter assembly 40 may absorb the front end of the film fabric 3 to which the first double-sided adhesive tape 8 is attached.

The first absorption moving roller 70 absorbs the front end of the base fabric 2 of the component fabric 1 that is wound in the first supply roll 10 with vacuum suction pressure. Here, the first absorption moving roller 70 may absorb the front end of the base fabric 2 to which the second double-sided adhesive tape 9 is attached.

In such a case, at a time point at which the component fabric 1 of the second supply roll 20 is exhausted, the first and second cutter assemblies 40 and 50 may rotate toward the transfer path 5 and attach the front end of the film fabric 3 of the first supply roll 10 and the end portion of the film fabric 3 of the second supply roll 20 through the first double-sided adhesive tape 8.

Further, the second cutter assembly 50 may absorb the end portion of the component fabric 1 of the second supply roll 20 with vacuum suction pressure through the second fabric absorption portion 53 and cut the end portion of the component fabric 1 of the second supply roll 20 through the second fabric cutter 55.

In a state in which the first and second cutter assemblies 40 and 50 are rotated to an original location, the first absorption moving roller 70 moves to the transfer path 5 side. Accordingly, the first absorption moving roller 70 attaches an end portion of the base fabric 2 of the component fabric 1 of the second supply roll 20 that is cut through the second cutter assembly 50 and the front end of the base fabric 2 of the component fabric 1 of the first supply roll 10 through the second double-sided adhesive tape 9 and moves to an original location.

Hereinafter, operation of an auto splicing apparatus 200 of roll to roll feeding equipment according to another exemplary embodiment of the present disclosure having the above-described configuration will be described in detail with reference to the accompanying drawings.

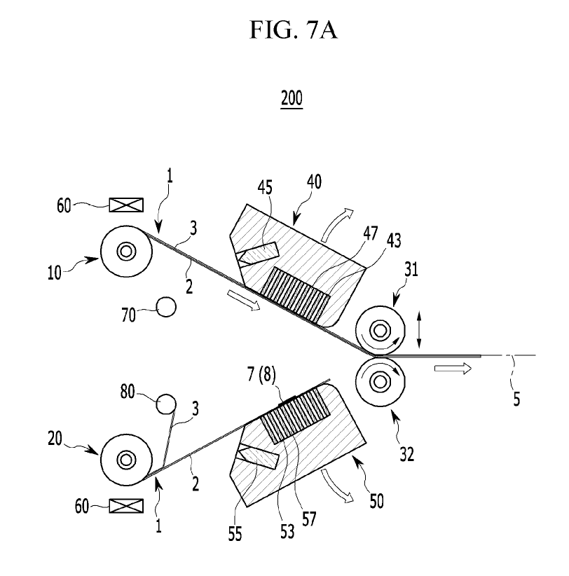

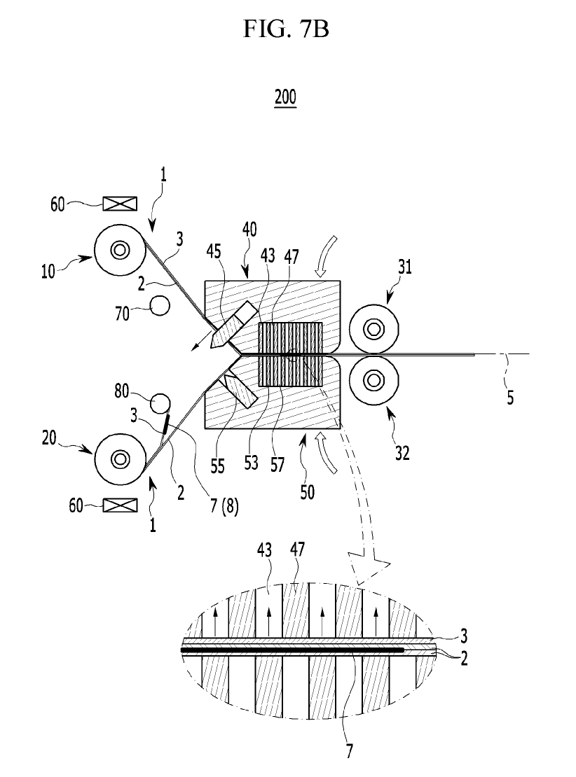

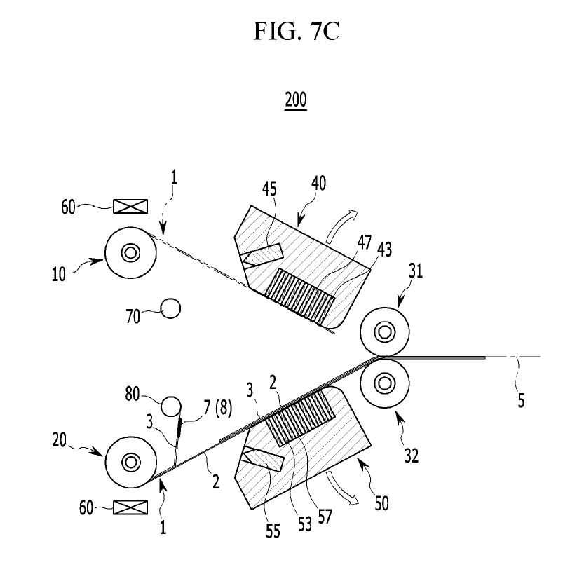

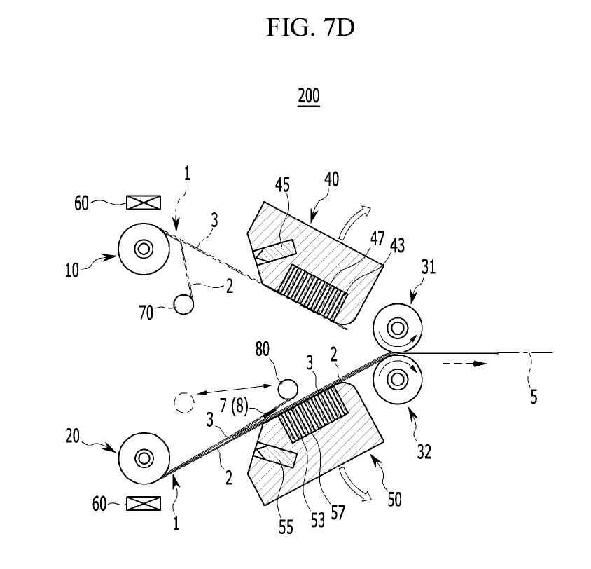

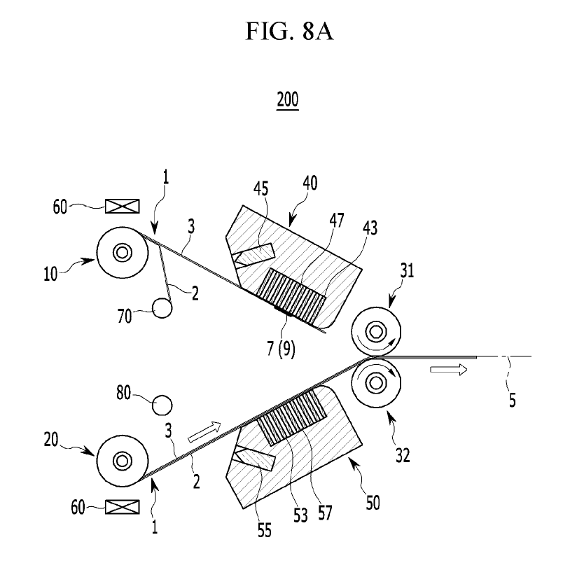

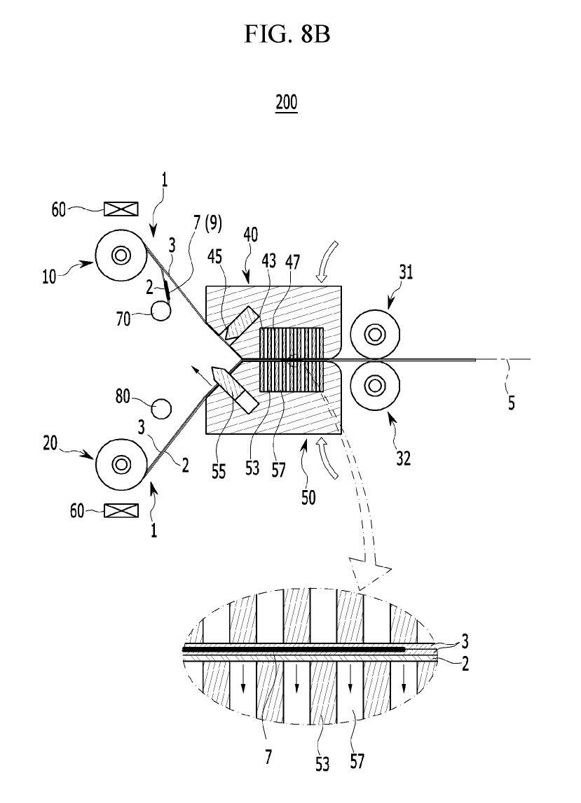

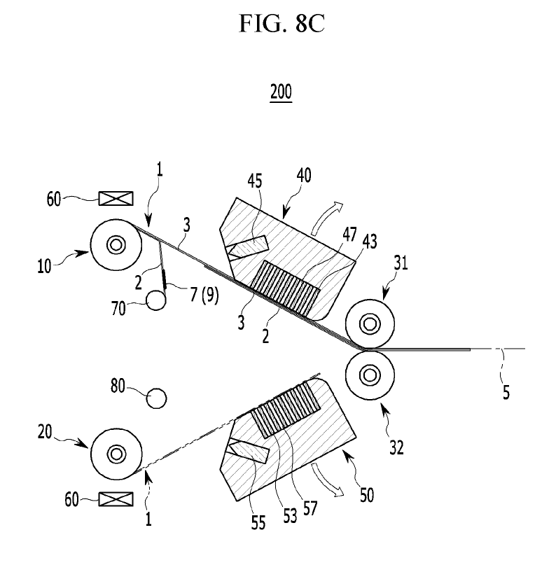

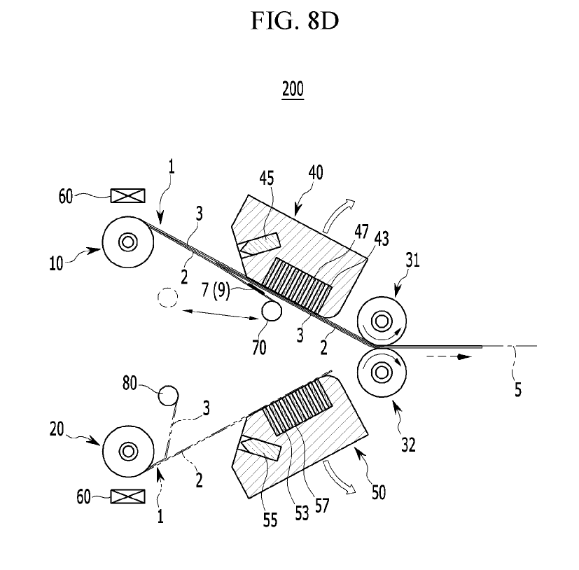

FIGS. 7A to 7D and 8A to 8D are schematic diagrams illustrating operation of an auto splicing apparatus of roll to roll feeding equipment according to an exemplary embodiment of the present disclosure.

Referring to FIG. 7A, in an exemplary embodiment of the present disclosure, when an initial first supply roll 10 is a work roll and when a second supply roll 20 is a preliminary roll, for example, at the upper side of the front side of a frame of the roll to roll feeding equipment, the first supply roll 10 is mounted.

In this case, in an exemplary embodiment of the present disclosure, in a state in which the upper feeding roller 31 is moved in an upward direction along a guide rail by a first driving source 33, the component fabric 1 of the first supply roll 10 is set to the transfer path 5. That is, the component fabric 1 of the first supply roll 10 is set between the upper feeding roller 31 and the lower feeding roller 32.

Thereafter, in an exemplary embodiment of the present disclosure, the upper feeding roller 31 is moved in a downward direction along a guide rail by the first driving source 33. Accordingly, the upper feeding roller 31 maintains a contact state with the lower feeding roller 32.

Thereafter, in an exemplary embodiment of the present disclosure, the second supply roll 20 is mounted at a lower portion of the first supply roll 10 at the front side of the frame. In this case, in an exemplary embodiment of the present disclosure, the first cutter assembly 40 rotates while drawing a revolving trajectory in an upward direction based on the transfer path 5 by a third driving source 41. The second cutter assembly 50 rotates while drawing a revolving trajectory in a downward direction based on the transfer path 5 by a fifth driving source 51. That is, the first and second cutter assemblies 40 and 50 rotate in a receding direction with the transfer path 5 interposed therebetween by the third driving source 41 and the fifth driving source 51, respectively. The first fabric cutter 45 and the second fabric cutter 55 of the first and second cutter assemblies 40 and 50 are in a backward state.

In such a state, in an exemplary embodiment of the present disclosure, vacuum suction pressure is applied to the vacuum suction holes 57 of the second fabric absorption portion 53 of the second cutter assembly 50, the front end of the base fabric 2 of the component fabric 1 of the second supply roll 20 is located at the second fabric absorption portion 53, and the front end of the base fabric 2 is absorbed in the second fabric absorption portion 53 with vacuum suction pressure through the vacuum suction holes 57.

Thereafter, in an exemplary embodiment of the present disclosure, the first double-sided adhesive tape 8 is attached to an upper surface of the front end of the base fabric 2 that is absorbed in the second fabric absorption portion 53. Further, in an exemplary embodiment of the present disclosure, vacuum suction pressure is applied to vacuum suction holes 81 of the second absorption moving roller 80, and the front end of the film fabric 3 of the component fabric 1 of the second supply roll 20 is absorbed in an external circumference surface of the second absorption moving roller 80 with vacuum suction pressure through the vacuum suction holes 81.

After the above process, in an exemplary embodiment of the present disclosure, the second driving source 35 is driven to rotate the upper feeding roller 31, rotate the lower feeding roller 32 contacting with the upper feeding roller 31, and feed the component fabric 1 of the first supply roll 10 entering between the rollers 31 and 32 in a post-process along the transfer path 5.

In such a process, in an exemplary embodiment of the present disclosure, the detecting sensor 60 detects whether the component fabric 1 of the first supply roll 10 is exhausted and outputs a detection signal thereof to a controller 90.

In an exemplary embodiment of the present disclosure, if the component fabric 1 of the first supply roll 10 is exhausted, as shown in FIG. 7B, the controller 90 applies a control signal to the second driving source 35 to stop a driving rotation of the upper feeding roller 31.

Thereafter, in an exemplary embodiment of the present disclosure, the controller 90 applies a control signal to the third driving source 41 to rotate the first cutter assembly 40 to the transfer path 5 side while drawing a revolving trajectory in a downward direction. In an exemplary embodiment of the present disclosure, the controller 90 applies a control signal to the fifth driving source 51 to rotate the second cutter assembly 50 to the transfer path 5 side while drawing a revolving trajectory in an upward direction. That is, the first and second cutter assemblies 40 and 50 rotate in an approaching direction with the transfer path 5 interposed therebetween by the third driving source 41 and the fifth driving source 51, respectively.

Accordingly, in an exemplary embodiment of the present disclosure, an end portion of the base fabric 2 of the component fabric 1 of the first supply roll 10 and the front end of the base fabric 2 of the component fabric 1 of the second supply roll 20 are attached through the first double-sided adhesive tape 8. In this case, the first cutter assembly 40 absorbs the end portion of the component fabric 1 of the first supply roll 10 by vacuum suction pressure that is applied to the vacuum suction holes 47 of the first fabric absorption portion 43. Therefore, the end portion of the base fabric 2 of the component fabric 1 of the first supply roll 10 and the front end of the base fabric 2 of the component fabric 1 of the second supply roll 20 may be pressed by a pressure of the first and second cutter assemblies 40 and 50 with the first double-sided adhesive tape 8 interposed therebetween and be attached through the first double-sided adhesive tape 8.

Simultaneously, in an exemplary embodiment of the present disclosure, the controller 90 applies a control signal to a fourth driving source 49 to move forward the first fabric cutter 45 of the first cutter assembly 40 and cuts the end portion of the component fabric 1 of the first supply roll 10 through the first fabric cutter 45.

In an exemplary embodiment of the present disclosure, in such a process, the second double-sided adhesive tape 9 is attached to the front end of the film fabric 3 of the component fabric 1 of the second supply roll 20 that is absorbed in an external circumference surface of the second absorption moving roller 80.

Thereafter, in an exemplary embodiment of the present disclosure, as shown in FIG. 7C, the controller 90 applies a control signal to the third driving source 41 to rotate the first cutter assembly 40 while drawing a revolving trajectory in an upward direction. In an exemplary embodiment of the present disclosure, the controller 90 applies a control signal to a fifth driving source 51 to rotate the second cutter assembly 50 while drawing a revolving trajectory in a downward direction. That is, the first and second cutter assemblies 40 and 50 rotate in a receding direction with the transfer path 5 interposed therebetween by the third driving source 41 and the fifth driving source 51, respectively.

Simultaneously, in an exemplary embodiment of the present disclosure, vacuum suction pressure operating in the first fabric absorption portion 43 of the first cutter assembly 40 is blocked. Accordingly, the end portion of the component fabric 1 of the first supply roll 10 that is cut by the first fabric cutter 45 of the first cutter assembly 40 is received in the second cutter assembly 50. Here, in the cut component fabric 1 of the first supply roll 10, the end portion of the base fabric 2 is attached to the front end of the base fabric 2 of the component fabric 1 of the second supply roll 20 through the first double-sided adhesive tape 8.

In such a state, in an exemplary embodiment of the present disclosure, as shown in FIG. 7D, the controller 90 applies a control signal to an eighth driving source 83 to move the second absorption moving roller 80 to the rear side of the frame of the transfer path 5 side along a guide rail. In this case, in a state in which the front end of the film fabric 3 of the component fabric 1 of the second supply roll 20 is absorbed in an external circumference surface with vacuum suction pressure, the second absorption moving roller 80 moves to the transfer path 5 side. The second double-sided adhesive tape 9 is attached to the front end of the film fabric 3 of the component fabric 1 of the second supply roll 20.

Therefore, in an exemplary embodiment of the present disclosure, the second absorption moving roller 80 attaches an end portion of the film fabric 3 of the component fabric 1 of the first supply roll 10 and the front end of the film fabric 3 of the component fabric 1 of the second supply roll 20 through the second double-sided adhesive tape 9. Thereafter, in an exemplary embodiment of the present disclosure, the controller 90 applies a control signal to the eighth driving source 83 to move the second absorption moving roller 80 to an original location (the front side of the frame) along a guide rail.

Thereby, in an exemplary embodiment of the present disclosure, through the above process, an end portion of the base fabric 2 of the component fabric 1 that is cut in the first supply roll 10, which is a work roll and the front end of the base fabric 2 of the component fabric 1 that is unwound from the second supply roll 20, which is a preliminary roll may be connected through the first double-sided adhesive tape 8. In an exemplary embodiment of the present disclosure, an end portion of the film fabric 3 of the component fabric 1 that is cut in the first supply roll 10 and the front end of the film fabric 3 of the component fabric 1 that is unwound from the second supply roll 20, which is a preliminary roll may be connected through the second double-sided adhesive tape 9.

After the above process, in an exemplary embodiment of the present disclosure, the second driving source 35 is driven to rotate the upper feeding roller 31, rotate the lower feeding roller 32 contacting with the upper feeding roller 31, and feed the component fabric 1 of the second supply roll 20 entering between the rollers 31 and 32 in a post-process along the transfer path 5.

That is, in an exemplary embodiment of the present disclosure, in a state in which the end portion of the component fabric 1 of the first supply roll 10 is attached to the front end of the component fabric 1 of the second supply roll 20 through the first and second double-sided adhesive tapes 8 and 9, the component fabric 1 of the second supply roll 20 continuously feeds in a post-process. Accordingly, in an exemplary embodiment of the present disclosure, the second supply roll 20, which is an initial preliminary roll performs a function of a work roll, and because the component fabric 1 has been exhausted, the first supply roll 10, which is an initial work roll is replaced with a new preliminary roll.

Referring to FIG. 8A, as described above, when the first supply roll 10 is a newly replaced preliminary roll and when the second supply roll 20 is a work roll, in an exemplary embodiment of the present disclosure, the component fabric 1 that is unwound from the second supply roll 20 enters between the upper feeding roller 31 and the lower feeding roller 32 and feeds in a post-process along the transfer path 5.

In such a case, in an exemplary embodiment of the present disclosure, vacuum suction pressure is applied to the vacuum suction holes 47 of the first fabric absorption portion 43 of the first cutter assembly 40, the front end of the film fabric 3 of the component fabric 1 of the first supply roll 10 is located at the first fabric absorption portion 43, and the front end of the film fabric 3 is absorbed in the first fabric absorption portion 43 with vacuum suction pressure through the vacuum suction holes 47.

Thereafter, in an exemplary embodiment of the present disclosure, the first double-sided adhesive tape 8 is attached to the front end of the film fabric 3 that is absorbed in the first fabric absorption portion 43. Further, in an exemplary embodiment of the present disclosure, vacuum suction pressure is applied to the vacuum suction holes 71 of the first absorption moving roller 70, and the front end of the base fabric 2 of the component fabric 1 of the first supply roll 10 is absorbed in an external circumference surface of the first absorption moving roller 70 with vacuum suction pressure through the vacuum suction holes 71.

As described above, in a process of feeding the component fabric 1 that is unwound from the second supply roll 20 in a post-process along the transfer path 5, in an exemplary embodiment of the present disclosure, the detecting sensor 60 detects whether the component fabric 1 of the second supply roll 20 is exhausted and outputs a detection signal thereof to the controller 90.

In an exemplary embodiment of the present disclosure, if the component fabric 1 of the second supply roll 20 is exhausted, as shown in FIG. 8B, the controller 90 applies a control signal to the second driving source 35 to stop a driving rotation of the upper feeding roller 31.

Thereafter, in an exemplary embodiment of the present disclosure, the controller 90 applies a control signal to the third driving source 41 to rotate the first cutter assembly 40 to the transfer path 5 side while drawing a revolving trajectory in a downward direction. In an exemplary embodiment of the present disclosure, the controller 90 applies a control signal to the fifth driving source 51 to rotate the second cutter assembly 50 to the transfer path 5 side while drawing a revolving trajectory in an upward direction. That is, the first and second cutter assemblies 40 and 50 rotate in an approaching direction with the transfer path 5 interposed therebetween by the third driving source 41 and the fifth driving source 51, respectively.

Accordingly, in an exemplary embodiment of the present disclosure, an end portion of the film fabric 3 of the component fabric 1 of the second supply roll 20 and the front end of the film fabric 3 of the component fabric 1 of the first supply roll 10 are attached through the first double-sided adhesive tape 8. In this case, the second cutter assembly 50 absorbs an end portion of the component fabric 1 of the second supply roll 20 by vacuum suction pressure that is applied to the vacuum suction holes 57 of the second fabric absorption portion 53. Therefore, an end portion of the film fabric 3 of the component fabric 1 of the second supply roll 20 and the front end of the film fabric 3 of the component fabric 1 of the first supply roll 10 may be pressed by a pressure of the first and second cutter assemblies 40 and 50 with the first double-sided adhesive tape 8 interposed therebetween and be attached through the first double-sided adhesive tape 8.

Simultaneously, in an exemplary embodiment of the present disclosure, the controller 90 applies a control signal to a sixth driving source 59 to move forward the second fabric cutter 55 of the second cutter assembly 50 and cuts an end portion of the component fabric 1 of the second supply roll 20 through the second fabric cutter 55.

In an exemplary embodiment of the present disclosure, in such a process, the second double-sided adhesive tape 9 is attached to the front end of the base fabric 2 of the component fabric 1 of the first supply roll 10 that is absorbed in an external circumference surface of the first absorption moving roller 70.

Thereafter, in an exemplary embodiment of the present disclosure, as shown in FIG. 8C, the controller 90 applies a control signal to the third driving source 41 to rotate the first cutter assembly 40 while drawing a revolving trajectory in an upward direction. In an exemplary embodiment of the present disclosure, the controller 90 applies a control signal to the fifth driving source 51 to rotate the second cutter assembly 50 while drawing a revolving trajectory in a downward direction. That is, the first and second cutter assemblies 40 and 50 rotate in a receding direction with the transfer path 5 interposed therebetween by the third driving source 41 and the fifth driving source 51, respectively.

Simultaneously, in an exemplary embodiment of the present disclosure, vacuum suction pressure operating in the second fabric absorption portion 53 of the second cutter assembly 50 is blocked. Accordingly, an end portion of the component fabric 1 of the second supply roll 20 that is cut by the second fabric cutter 55 of the second cutter assembly 50 is received in the first cutter assembly 40. Here, in the cut component fabric 1 of the second supply roll 20, an end portion of the film fabric 3 is attached to the front end of the film fabric 3 of the component fabric 1 of the first supply roll 10 through the first double-sided adhesive tape 8.

In such a state, in an exemplary embodiment of the present disclosure, as shown in FIG. 8D, the controller 90 applies a control signal to a seventh driving source 73 to move the first absorption moving roller 70 to the rear side of the frame of the transfer path 5 side along a guide rail. In this case, in a state in which the front end of the base fabric 2 of the component fabric 1 of the first supply roll 10 is absorbed in an external circumference surface with vacuum suction pressure, the first absorption moving roller 70 is moved to the transfer path 5 side. The second double-sided adhesive tape 9 is attached to the front end of the base fabric 2 of the component fabric 1 of the first supply roll 10.

Therefore, in an exemplary embodiment of the present disclosure, the first absorption moving roller 70 attaches an end portion of the base fabric 2 in the component fabric 1 of the second supply roll 20 and the front end of the base fabric 2 of the component fabric 1 of the first supply roll 10 through the second double-sided adhesive tape 9. Thereafter, in an exemplary embodiment of the present disclosure, the controller 90 applies a control signal to a seventh driving source 73 to move the first absorption moving roller 70 to an original location (the front side of the frame) along a guide rail.

Thereby, in an exemplary embodiment of the present disclosure, through the above process, an end portion of the film fabric 3 of the component fabric 1 that is cut in the second supply roll 20, which is a work roll and the front end of the film fabric 3 of the component fabric 1 that is unwound from the first supply roll 10, which is a preliminary roll may be connected through the first double-sided adhesive tape 8. In an exemplary embodiment of the present disclosure, an end portion of the base fabric 2 of the component fabric 1 that is cut in the second supply roll 20 and the front end of the base fabric 2 of the component fabric 1 that is unwound from the first supply roll 10, which is a preliminary roll may be connected through the second double-sided adhesive tape 9.

After the above process, in an exemplary embodiment of the present disclosure, the second driving source 35 is driven to rotate the upper feeding roller 31, rotate the lower feeding roller 32 contacting with the upper feeding roller 31, and feed the component fabric 1 of the first supply roll 10 entering between the rollers 31 and 32 in a post-process along the transfer path 5.

That is, in a state in which an end portion of the component fabric 1 of the second supply roll 20 is attached to the front end of the component fabric 1 of the first supply roll 10 through the first and second double-sided adhesive tapes 8 and 9, the component fabric 1 of the first supply roll 10 continuously feeds in a post-process. Accordingly, in an exemplary embodiment of the present disclosure, the first supply roll 10, which is a preliminary roll performs a function of a work roll and because the component fabric 1 has been exhausted, the second supply roll 20, which is a work roll is replaced with a new preliminary roll.

In an auto splicing apparatus 200 of roll to roll feeding equipment according to another exemplary embodiment of the present disclosure of the foregoing description, in the roll to roll feeding equipment, an end portion of the component fabric 1 that is unwound from a work roll among the first and second supply rolls 10 and 20 in which the component fabric 1 of two layers is wound in a roll form is automatically connected to the front end of the component fabric 1 that is unwound from a preliminary roll and thus the component fabric 1 may be continuously supplied.

Therefore, a work time and a non-operation time of a production process for connecting component fabric of a work roll and a preliminary roll can be shortened, and productivity of a battery component can be further improved.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. An auto splicing apparatus of roll to roll feeding equipment comprising a first supply roll and a second supply roll in which component fabric of a single layer is wound in a roll form and the component fabric is unwound from the first supply roll or the second supply roll along a predetermined transfer path, the auto splicing apparatus comprising:
a pair of feeding rollers that are disposed at upper and lower sides, respectively, of the transfer path and that transfer the component fabric while rotating and being engaged with each other and configured to perform a vertical movement and driving rotation;
a first cutter assembly that is installed to perform a vertical rotation based on the transfer path between the first supply roll and the feeding roller and comprising a first fabric cutter and a first fabric absorption portion; and
a second cutter assembly that is installed to perform a vertical rotation based on the transfer path between the second supply roll and the feeding roller and comprising a second fabric cutter and a second fabric absorption portion.

2. The auto splicing apparatus of claim 1, further comprising detecting sensors that are installed at sides of the first supply roll and second supply roll, respectively, and configured to detect whether the component fabric of each roll is exhausted and output a detection signal to a controller.

3. The auto splicing apparatus of claim 2, wherein at least one of the detecting sensors detects a diameter of the component fabric that is wound in the first and second supply rolls.

4. The auto splicing apparatus of claim 2, wherein at least one of the detecting sensors detects a label of an end portion side of the component fabric that is wound in the first and second supply rolls.

5. The auto splicing apparatus of claim 1, wherein the second cutter assembly absorbs a front end of the component fabric that is wound in the second supply roll with vacuum suction pressure through the second fabric absorption portion and absorbs the front end of the component fabric to which a double-sided adhesive tape is attached, wherein the first supply roll is a work roll and the second supply roll is a preliminary roll, and
the first cutter assembly absorbs the front end of the component fabric that is wound in the first supply roll with vacuum suction pressure through the first fabric absorption portion and absorbs the front end of the component fabric to which a double-sided adhesive tape is attached, wherein the first supply roll is a preliminary roll and when the second supply roll is a work roll.

6. The auto splicing apparatus of claim 5, wherein the first and second cutter assemblies when the first supply roll is a work roll and when the second supply roll is a preliminary roll rotate toward the transfer path and attach the front end of the component fabric of the second supply roll and an end portion of the component fabric of the first supply roll through the double-sided adhesive tape at a time point at which the component fabric of the first supply roll is exhausted.

7. The auto splicing apparatus of claim 6, wherein the first cutter assembly absorbs the end portion of the component fabric of the first supply roll with vacuum pressure through the first fabric absorption portion and cuts the end portion of the component fabric of the first supply roll through the first fabric cutter.

8. The auto splicing apparatus of claim 5, wherein the first and second cutter assemblies when the first supply roll is a preliminary roll and when the second supply roll is a work roll rotate toward the transfer path and attach the front end of the component fabric of the first supply roll and an end portion of the component fabric of the second supply roll through the double-sided adhesive tape at a time point at which the component fabric of the second supply roll is exhausted.

9. The auto splicing apparatus of claim 8, wherein the second cutter assembly absorbs the end portion of the component fabric of the second supply roll with vacuum pressure through the second fabric absorption portion and cuts the end portion of the component fabric of the second supply roll through the second fabric cutter.

10. The auto splicing apparatus of claim 1, wherein a scale is provided in the first and second fabric absorption portions of the first and second cutter assemblies.

11. An auto splicing apparatus of roll to roll feeding equipment comprising first and second supply rolls in which component fabric of two layers in which film fabric is attached to base fabric is wound in a roll form and that supplies the component fabric that is unwound from the first supply roll or the second supply roll along a predetermined transfer path, the auto splicing apparatus comprising:
a pair of feeding rollers that are disposed at upper and lower sides, respectively, of the transfer path and that transfer the component fabric while rotating with engaged each other and configured to perform a vertical movement and driving rotation;
a first cutter assembly that is installed to perform a vertical rotation based on the transfer path between the first supply roll and the feeding roller and comprising a first fabric cutter and a first fabric absorption portion;
a second cutter assembly that is installed to perform a vertical rotation based on the transfer path between the second supply roll and the feeding roller and comprising a second fabric cutter and a second fabric absorption portion; and
first and second absorption moving rollers that are rotatably provided at the first and second supply rolls sides, respectively and that are installed to perform a reciprocating movement along the transfer path and that absorb base fabric and film fabric of the component fabric that is wound in the first and second supply rolls, respectively.

12. The auto splicing apparatus of claim 11, further comprising detecting sensors that are installed at the first and second supply rolls sides, respectively and that detect whether the component fabric of each roll is exhausted and that outputs a detection signal thereof to a controller.

13. The auto splicing apparatus of claim 11, wherein the second cutter assembly absorbs the front end of base fabric of the component fabric that is wound in the second supply roll with vacuum suction pressure through the second fabric absorption portion and absorbs the front end of base fabric to which a double-sided adhesive tape is attached, and the second absorption moving roller absorbs the front end of film fabric of the component fabric that is wound in the second supply roll with vacuum suction pressure and absorbs the front end of film fabric to which a double-sided adhesive tape is attached, when the first supply roll is a work roll and when the second supply roll is a preliminary roll.

14. The auto splicing apparatus of claim 13, wherein the first and second cutter assemblies rotate toward the transfer path and attach the front end of base fabric of the second supply roll and an end portion of base fabric of the first supply roll through the first double-sided adhesive tape at a time point at which the component fabric of the first supply roll is exhausted, and
the first cutter assembly absorbs the end portion of the component fabric of the first supply roll with vacuum pressure through the first fabric absorption portion and cuts the end portion of the component fabric of the first supply roll through the first fabric cutter.

15. The auto splicing apparatus of claim 14, wherein the second absorption moving roller moves to the transfer path side, attaches the end portion of film fabric of the component fabric of the first supply roll that is cut through the first cutter assembly and the front end of film fabric of the component fabric of the second supply roll through the second double-sided adhesive tape, and moves to an original location in a state in which the first and second cutter assemblies are rotated to an original location.

16. The auto splicing apparatus of claim 11, wherein the first cutter assembly absorbs the front end of film fabric of the component fabric that is wound in the first supply roll with vacuum suction pressure through the first fabric absorption portion and absorbs the front end of film fabric to which a first double-sided adhesive tape is attached, and the first absorption moving roller absorbs the front end of base fabric of the component fabric that is wound in the first supply roll with vacuum suction pressure and absorbs the front end of base fabric to which a second double-sided adhesive tape is attached, when the first supply roll is a preliminary roll and when the second supply roll is a work roll.

17. The auto splicing apparatus of claim 16, wherein the first and second cutter assemblies rotate toward the transfer path and attach the front end of film fabric of the first supply roll and an end portion of film fabric of the second supply roll through the first double-sided adhesive tape at a time point at which the component fabric of the second supply roll is exhausted, and
the second cutter assembly absorbs the end portion of the component fabric of the second supply roll with vacuum pressure through the second fabric absorption portion and cuts the end portion of the component fabric of the second supply roll through the second fabric cutter.

18. The auto splicing apparatus of claim 17, wherein the first absorption moving roller moves to the transfer path side, attaches the end portion of base fabric of the component fabric of the second supply roll that is cut through the second cutter assembly and the front end of base fabric of component fabric of the first supply roll through the second double-sided adhesive tape, and moves to an original location in a state in which the first and second cutter assemblies are rotated to an original location.

19. The auto splicing apparatus of claim 11, wherein a scale is provided in the first and second fabric absorption portions of the first and second cutter assemblies.
